(19) United States
(12) Patent Application Publication
(10) Pub. No.: US 2011/0291844 A1
(43) Pub. Date: Dec. 1, 2011

(54) WATER ALARM

(75) Inventors: Steven J. Kelchlin, San Diego, CA (US); Jay Brandt, San Diego, CA (US); Mark Mallaby, San Diego, CA (US)

(73) Assignee: BRALIN COMPANY, San Diego, CA (US)

(21) Appl. No.: 13/104,946

(22) Filed: May 10, 2011

Related U.S. Application Data
(60) Provisional application No. 61/347,937, filed on May 25, 2010.

(51) Int. Cl. G08B 21/00

(52) U.S. Cl. 340/603

(57) ABSTRACT

The present invention provides an alarm for detecting and alerting of a water spill, having an audible transducer angled for optimally transmitting an alarm sound into a space adjacent to the alarm.

Devices for the detection of fluids that spilled, leaked or otherwise deposited on a floor are common place. The disadvantages of these devices are physical size, single plane detection means and alert transducer orientation. These disadvantages make it less likely that an audible alarm sounding from the device will be heard.

The present invention solves the design shortcomings of other water alarms in a compact, efficient manner by orienting an audible transducer at an angle to the device body to maximize the volume of alarm sounds that are transmitted into a space adjacent to the device, such as into the room and not toward a wall, floor, cabinets or other equipment.

### BRIEF DESCRIPTION OF THE DRAWINGS

FIG. 1 is an illustration of a top view a water alarm device of the invention with reference to the following features:

10—Upper Enclosure;

12—Lower Enclosure

14—First Sensing Element

16—Second Sensing Element

18—Audible Transducer

20—Electronic Circuit

22—Battery

24—Angled Transducer Surface

FIG. 2 is an illustration of a bottom view of a water alarm device of the invention with reference to the following features:

10—Upper Enclosure;

12—Lower Enclosure

14—First Sensing Element

16—Second Sensing Element

18—Audible Transducer

20—Electronic Circuit

22—Battery

24—Angled Transducer Surface

### DETAILED DESCRIPTION

The water alarm according to the present invention, comprises a generally hollow, rectangular body comprising an upper enclosure member 10 and a lower enclosure member 12, which may be made of any non-corrosive, water resistant material, such as plastic. In certain embodiments, a battery access panel or port 26 is disposed on either of the upper enclosure 10 and a lower enclosure 12. Enclosed within the body 10 is an electronic circuit board 20 or other means for receiving input from a first water sensing element 14 and/or a second, optional water sensing element 16, where the first and second water sensing elements are in electronic communication with the electronic circuit board. The first and second water sensing elements 14 and 16 are generally disposed on an exterior surface of the lower enclosure member 12 such that when water is present, the water will contact at least one of the water sensing elements, and thereby transmit a signal to the electronic circuit board 20 or other means for receiving water sensing input. The electronic circuit board 20 or other means for receiving input is in turn, in communication (e.g., electronic communication) with an audible transducer 18 capable of generating an audible sound or alarm in response to the presence of water. In certain embodiments, the audible transducer 18 is a speaker.

The audible transducer 18 is positioned at an angle relative to the to the lower enclosure member, such that the audible sound or alarm produced by the audible transducer 18 is directed away from the water. For example, the lower enclosure member 12 of the water alarm according to the present invention may be placed on a floor or other surface that may be accidentally flooded or for which the presence of water is to be detected. The audible transducer 18 according to such embodiments, will be directed generally upwardly to maximize the alarm sound that is audible to an operator. In other embodiments, the audible transducer 18 will be directed generally both upwardly and outwardly. Such embodiments are useful where the alarm will be located in a corner or under an appliance (e.g. a washing machine) or other obstruction. In certain aspects, the placement of the audible transducer 18 will direct the alarm at an angle between 15 and 90 degrees, typically 20 to 60 degrees and often 30 to 45 degrees relative to the source of water. In yet further embodiments, the audible transducer may be directed by the operator in at least one orientation relative to the source of the water. By way of example only, audible transducer 18 may disposed in a pivotable and/or rotateable manner within the body of the alarm, such that the alarm sound produced thereby in a given location of the water alarm can be adjusted for maximal detection by a remotely located operator.

In certain embodiments a combination of water sensing elements allow fluid detection with the device placed in multiple positions to accommodate small or low spaces. In certain embodiments an audible transducer is mounted at an angle that complements the allowable detection positions to allow enhanced transmission of the alert tone to surrounding spaces.

What is claimed is:

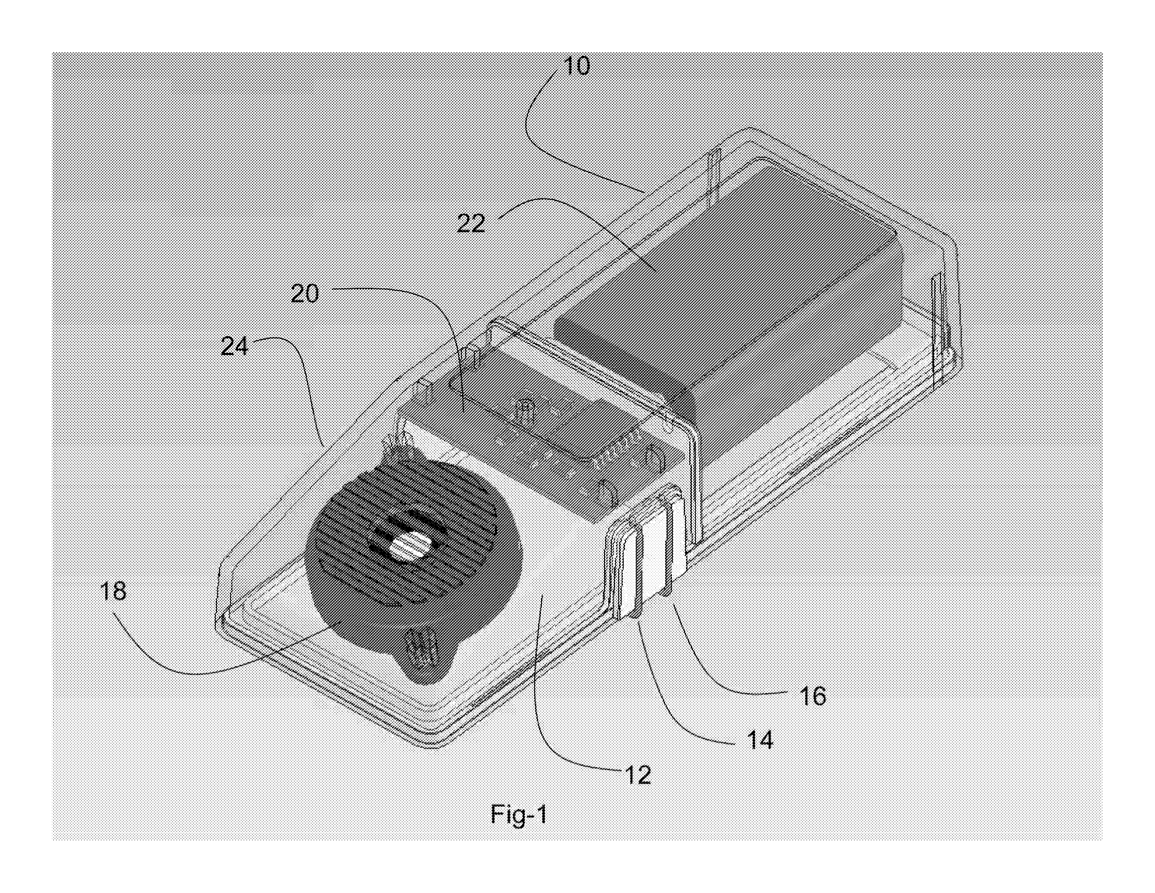

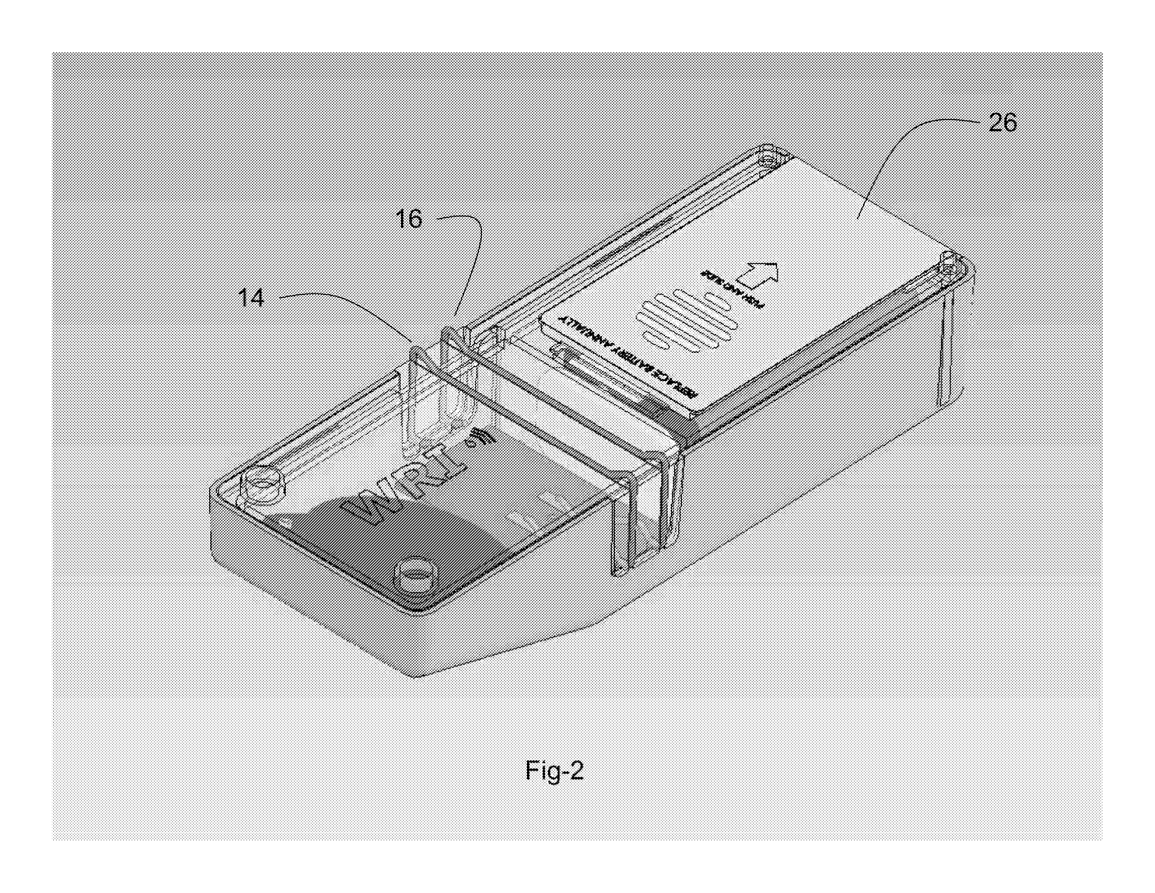

1. A device for detecting the presence of water as shown in FIGS. 1 and 2.

2. The deice of claim 1, wherein the device comprises an upper enclosure, a lower enclosure, at least one water sensing element, an audible transducer, an electronic circuit, a battery, and an angled transducer surface.

3. The device of claim 2, wherein the transducer surface is angled to maximize sound transmission into an adjacent area.

4. The device of claim 1, wherein the device transmits an audible alert in the presence of water via an audible transducer.

5. The device of claim 4, wherein the audible transducer is oriented to efficiently transmit the alert.

6. The device of claim 1, wherein water is detected by the device in a plurality of physical orientations.

7. The device of claim 1, wherein the transducer is oriented to efficiently transmit the alert when water is present at the bottom, top or a side of the device.
